(19) United States
(12) Patent Application Publication
(10) Pub. No.: US 2015/0150287 A1
(43) Pub. Date: Jun. 4, 2015

(54) COMPOSITION

(71) Applicant: DuPont Nutrition Biosciences ApS, Copenhagen K (DK)

(72) Inventors: Henrik Kragh, Viby J (DK); Hans Hedegaard Jensen, Horsens (DK); Finn Madsen, Abyhoj (DK); Bente Simonsen, Odder (DK)

(21) Appl. No.: 14/405,915

(22) PCT Filed: Jun. 3, 2013
(86) PCT No.: PCT/EP2013/061378

§ 371 Date: Dec. 5, 2014

(30) Foreign Application Priority Data
Jun. 7, 2012 (GB) 1210060.8

(51) Int. Cl. A23L 1/035; A23L 1/00; A21D 13/08; A23L 1/09

(52) U.S. Cl. CPC A23L 1/035; A23L 1/092; A23L 1/0017; A21D 13/08; A23L 1/0097; A23L 1/097; A23V 2002/00

(57) ABSTRACT

There is provided a composition comprising (a) a food ingredient, the hydration of which is to be enhanced; (b) a water soluble particulate material, having an average particle size of from 10 to 1000 μm; wherein the food ingredient and the water soluble particulate material are integrated with each other.

The present invention relates to an integrated composition comprising a food ingredient, the hydration of which is to be enhanced; and a water soluble material.

Integrated blends of emulsifiers and additional components such as stabilisers are known in the art.

It is known that food ingredients which are not readily hydratable, such as emulsifiers, when provided alone may fail to exhibit their desired properties and therefore may fail to form a satisfactory dispersion, emulsion or suspension. On hydration, prior to dispersion/dissolution in aqueous media, it is often found that the food ingredients have a tendency to form lumps. This tendency to form lumps has been addressed by the use of wetting agents or suspension of the food ingredients in anhydrous organic liquids such as ethyl alcohol. Both of these proposed solutions are disadvantageous.

GB-A-1082283 addresses the problems of providing mixtures of an emulsifier and a stabiliser. GB-A-1082283 discusses that emulsifier and stabilisers are commonly used in the production of foodstuffs, either alone or in combination. GB-A-1082283 addresses the problems discussed by providing a particulate combined emulsifier and stabiliser composition. GB-A-1082283 teaches that the combined system may be obtained by spray-drying, although drying on belts or drums is also envisaged.

EP-A-0153870 relates to a powder product comprising one or more surface-active substances applied on a carrier. The carrier may be selected from bran products such as bean bran. The surface active material may be an emulsifier. A product is obtained by extrusion of the surface-active substance and carrier.

WO01/05246 relates to the delivery of an emulsifier and to the improvement of its dispersion. WO01/05246 teaches a process for the preparation of a composition comprising at least one emulsifier and at least one edible fibre, the process comprising i) providing an initial composition comprising the emulsifier in a melted form and the edible fibre, ii) spray crystallising the initial composition such that the emulsifier crystallises and the edible fibre are integrated. In addition to the emulsifier and the edible fibre, WO01/05246 teaches that the composition may further comprise an emulsifier improver.

The emulsifier improver may be incorporated in the initial composition and spray crystallised with the composition or may be added after spray crystallisation of the edible fibre and emulsifier. By the term “emulsifier improver” it is meant a material which enhances the distribution and/or emulsifying action of an emulsifier when compared to the distribution and/or emulsifying action of the emulsifier in absence of the material. The emulsifier improver may be a swelling improver or a non-swelling improver. By the terms “swelling” and “non-swelling” it is meant the properties of the emulsifier improver on contact of the present composition with water. The emulsifier improver may be selected from hydrocolloids, fibres, salts, proteins, sugars and combinations thereof.

The present invention alleviates the problems of the prior art.

In one aspect the present invention provides a composition comprising

(a) a food ingredient, the hydration of which is to be enhanced;
(b) a water soluble particulate material, having an average particle size of from 10 to 1000 μm;
wherein the food ingredient and the water soluble particulate material are integrated with each other.

In one aspect the present invention provides a process for the preparation of composition comprising
(a) a food ingredient, the hydration of which is to be enhanced;
(b) a water soluble particulate material, having an average particle size of from 10 to 1000 μm;
   the process comprising
   i) providing an initial composition comprising the food ingredient and the water soluble particulate material,
   ii) spray crystallising the initial composition such that the food ingredient and the water soluble particulate material are integrated with each other.

In one aspect the present invention provides use of a water soluble particulate material, having an average particle size of from 10 to 1000 μm; for improving the hydration of a food ingredient, wherein the food ingredient and the water soluble particulate material are integrated with each other.

We have surprisingly found that by spray crystallising a food ingredient with a specific water soluble particulate material, namely a water soluble particulate material having an average particle size of from 10 to 1000 μm, an integrated composition is obtained in which easily accessible channels are formed in the food ingredient. When contacted with water, the water will access this channel system. These channels allow for improved ingress of the water into the integrated composition. The improved ingress provides more rapid disintegration of the product and improved functional properties. This result is surprising and allows for the provision of an integrated product which has acceptable disintegration properties, yet does not require production by energy consuming techniques such as spray drying or extrusion, and does not require the addition of materials such as fibres.

The present invention provides an integrated composition comprising a food ingredient and a water soluble particulate material. The blend may be used in the production of cakes, in particular for whipped low-fat sponge cake. By integrating the water soluble particulate material and the food ingredient using spray crystallisation, we may improve the whipability of products prepared with the emulsifier.

Without being bound by theory, we understand that when the water soluble particulate material is mixed with a food ingredient and then spray crystallised, the water soluble particulate material will be located as separate particles or islands in the matrix. Some of the particles will also be located on the surface of the product and thereby be sitting partly outside and partly inside the product. When such a product is contacted with water, the water soluble particulate material will start to dissolve and thereby leave tunnels and open areas inside the product. These tunnels and open areas make a drastic increase in the surface area of the product and thereby help a fast hydration. Also these tunnels and open areas make the particles more fragile, eroding the particles during whipping and thereby further increasing surface area. We have called this a diffusion-controlled or erosion-controlled hydration process. We have found that the speed of the hydration depends both on the amount of water soluble particulate material and its particle size.

It has been found that compositions of the present invention may provide a composition which is more readily hydrated than the prior art compositions containing fibres. It has been found the present compositions may be more rapidly hydrated, more completely hydrated or both more rapidly and more completely hydrated. In use, the present compositions also provide food products with improved properties, for example the present compositions may provide a batter, which may be used in production of a cake, which can be whipped to a higher volume. This finding is surprising.

For ease of reference, these and further aspects of the present invention are now discussed under appropriate section headings. However, the teachings under each section are not necessarily limited to each particular section.

### DETAILED DESCRIPTION

As discussed herein, the present invention provides a composition comprising

(a) a food ingredient, the hydration of which is to be enhanced;
(b) a water soluble particulate material, having an average particle size of from 10 to 1000 μm;
wherein the food ingredient and the water soluble particulate material are integrated with each other.

It will be understood by one skilled in the art that by the term “integrated” it is meant that the composition of the present invention comprises both the water soluble particulate material and the food ingredient, and particles of the composition of the present invention comprise both water soluble particulate material and the food ingredient at the exterior of particles of composition, and particles of the composition of the present invention comprise both water soluble particulate material and the food ingredient at the interior of particles of composition. This is to be compared to encapsulated particles in which one material provides a covering or shell on the exterior of particles.

### Food Ingredient

It will be appreciated by one skilled in the art that the present invention encompasses any food ingredient, the hydration of which is to be enhanced. Such food ingredients are typically not readily hydrated when contacted with water, for example they may not be readily wettable. Such food ingredients may include hydrophobic materials and amphiphilic materials i.e. those which are both lipophilic and hydrophilic. The food ingredient may be selected from the group consisting of emulsifiers, triglycerides, fatty acids and hydrocolloids.

Food ingredients which may be delivered in the present composition include fatty acids and salts of fatty acids. Fatty acids which may be delivered may be selected from the group consisting of fatty acids having a chain length between C8 and C22. The fatty acids may be saturated fatty acids, unsaturated fatty acids or combinations thereof. Salts of fatty acids (often called soaps) which may be delivered may be selected from the group consisting of fatty acids having a chain length between C8 and C22 and sodium or potassium counter ions. As examples can be mentioned sodium or potassium stearate and sodium or potassium behenate.

A preferred food ingredient which may be advantageously delivered in the present composition is an emulsifier. Preferred emulsifiers may be selected from the group consisting of propylene glycol monostearate (PGMS), sodium stearoyl lactylate (SSL), calcium stearoyl lactylate (CSL), monoglycerides, diglycerides, monodiglycerides, polyglycerol esters (PGE), lactic acid esters of monoglycerides, lactic acid esters of diglycerides, lactic acid esters of monodiglycerides, polysorbate, sucrose esters of monoglycerides, sucrose esters of diglycerides, sucrose esters of monodiglycerides, diacetyl tartaric acid esters of monoglycerides, diacetyl tartaric acid esters of diglycerides, diacetyl tartaric acid esters of monodiglycerides (DATEM), citric acid esters of monoglycerides, citric acid esters of diglycerides, citric acid esters of monodiglycerides (CITREM) and combinations thereof.

In a preferred aspect the food ingredient is an emulsifier selected from the group consisting of monoglycerides. Thus in a preferred aspect the present invention provides a composition comprising

(a) a monoglyceride;
(b) a water soluble particulate material, having an average particle size of from 10 to 1000 μm;
wherein the food ingredient and the water soluble particulate material are integrated with each other.

Many emulsifiers are polymorphic meaning that they can exist in different crystalline forms. In some aspects the emulsifier may be in alpha crystal form or in beta crystal form. The beta form is the most stable but most often the alpha form is known to be the most functional. This is the case for whipping emulsifiers. When the composition of the present invention is used in a whippable product such as cake batters or ice cream mixes, the emulsifier is preferably in alpha crystal form. In one aspect the composition preferably comprises an emulsifier in alpha crystal form. When the composition of the present invention is used in a product in which whipability is not required, such as in bread dough or high ratio fat cakes, the emulsifier may be in beta crystal form. In one aspect the composition comprises an emulsifier in beta crystal form.

The composition may comprise only one emulsifier. The composition may comprise at least two emulsifiers. The composition may comprise at least three emulsifiers.

As discussed herein the beta form of emulsifiers is the most stable but most often the alpha form is known to be the most functional. This is the case for whipping emulsifiers. Therefore a whipping emulsifier often consist of emulsifiers that when present in the alpha form are very functional but they prefer to be in the beta form. In one aspect the composition comprises at least two emulsifiers wherein the first emulsifier is in alpha crystal form and the second emulsifier inhibits the conversion of the first emulsifier from alpha crystal form to another crystal form, such as the beta crystal form. The first emulsifier could be a mono glyceride. In this aspect, for example when providing a whipping emulsifiers, the composition comprises functional emulsifiers that are kept in their alpha crystalline form by alpha tending emulsifiers. These alpha tending emulsifiers keeps the functional emulsifiers in their alpha crystalline form and thereby ensures good whipping properties. Such alpha tending emulsifiers could be taken from the range of emulsifiers and in one aspect are selected from the groups consisting of propylene glycol monostearate (PGMS), polyglycerol esters (PGE), sodium stearoyl lactylate (SSL), diacetyl tartaric acid ester of mono- and diglycerides (DATEM), lactic acid esters of mono and diglycerides (LACTEM), glycerol monostearate (GMS) and acetylated monoglycerides (AcMG). The action of alpha tending emulsifiers are described in further detail in WO 2005/089568.

In one aspect the composition comprises at least three emulsifiers wherein the first emulsifier is in alpha crystal form, the second emulsifier inhibits the conversion of the first emulsifier from alpha crystal form to another crystal form (often called an alpha tending emulsifier), and the third emulsifier enhances the dispersion of the first emulsifier and/or the dispersion of the second emulsifier. Examples of emulsifiers that enhance the dispersion are sodium stearoyl lactylate (SSL), calcium stearoyl lactylate (CSL) and salts of fatty acids (soaps) such as sodium stearate, potassium stearate and other very hydrophilic (high HLB value) emulsifiers.

In one aspect the composition comprises at least three emulsifiers wherein the first emulsifier is a mono/diglyceride, the second emulsifier is propylene glycol monostearate (PGMS), and the third emulsifier is selected from sodium stearoyl lactylated (SSL), calcium stearoyl lactylate (CSL), a fatty acid salt and mixtures thereof. In one aspect the composition comprises at least three emulsifiers wherein the first emulsifier is a mono/diglyceride, the second emulsifier is propylene glycol monostearate (PGMS), and the third emulsifier is selected from sodium stearoyl lactylated (SSL), calcium stearoyl lactylate (CSL), sodium stearate, sodium behenate, potassium stearate, potassium behenate and mixtures thereof. In one aspect the composition comprises at least three emulsifiers wherein the first emulsifier is a mono/diglyceride, the second emulsifier is propylene glycol monostearate (PGMS), and the third emulsifier is selected from sodium stearoyl lactylated (SSL), calcium stearoyl lactylate (CSL) and mixtures thereof.

In one aspect the composition comprises at least two emulsifiers wherein the first emulsifier is a polyglycerol ester of fatty acids, and the second emulsifier is selected from sodium stearoyl lactylated (SSL), calcium stearoyl lactylate (CSL) and mixtures thereof.

Emulsifiers used in the preparation of products such as whipped products are generally in the α-crystal form, which facilitates the uptake of water in to the composition. When the composition is contacted with water the emulsifier quickly brings the water into the composition. It is generally understood that spray dried emulsifier products are able to provide emulsifiers in the α-crystalline form. This is because spray-drying retains emulsifiers provided in the α-crystalline form predominantly in that form. A significant disadvantage of using spray drying however is that large amounts of water or other solvents are removed from the composition during the drying process. The removal of water/solvent is at a substantial energy cost.

### Water Soluble Particulate Material

As discussed herein, a water soluble particulate material is provided. By “water soluble” it is meant a material having a solubility in water at 25° C. of at least 50 g/L, such as at least 100 g/L, such as at least 150 g/L, such as at least 200 g/L, such as at least 250 g/L, such as at least 300 g/L.

The water soluble particulate material may be selected from any material suitable for the desired application. As will be understood from the context of the present invention, typically the water soluble particulate material will be a water soluble food ingredient. In one aspect the water soluble particulate material is selected from the group consisting of sugars, sugar alcohols, salts and combinations thereof. In one aspect the water soluble particulate material is selected from the group consisting of sugars, sugar alcohols, and combinations thereof. In one aspect the water soluble particulate material is selected from the group consisting of sugars, salts and combinations thereof. In one aspect the water soluble particulate material is selected from the group consisting of sugar alcohols, salts and combinations thereof. In one aspect the water soluble particulate material is selected from sugars. In one aspect the water soluble particulate material is selected from sugar alcohols. In one aspect the water soluble particulate material is selected from salts.

In one preferred aspect the sugar is a monosaccharide or disaccharide. Thus in one preferred aspect, the sugar or sugar alcohol is selected from the group consisting of monosaccharides, disaccharides, sugar alcohols and combinations thereof.

As is known by one skilled in the art, a sugar alcohol is a hydrogenated form of carbohydrate, whose carbonyl group (aldehyde or ketone, reducing sugar) has been reduced to a primary or secondary hydroxyl group (hence the alcohol). Sugar alcohols have the general formula H(HCHO)ₙ₊₁H, whereas sugars have H(HCHO)ₙHCO.

In one aspect, the sugar alcohol is selected from the group consisting of artificial sweeteners.

In one aspect, the sugar alcohol is selected from the group consisting of glycol, glycerol, erythritol, threitol, arabitol, xylitol, ribitol, mannitol, sorbitol, galactitol, fucitol, iditol, inositol, volemitol, isomalt, maltitol, lactitol, polyglycitol, and mixtures thereof.

In one aspect, the sugar or sugar alcohol is selected from the group consisting of sucrose, lactose, glucose, maltose, mannitol and combinations thereof.

Preferably the sugar or sugar alcohol is selected from the group consisting of sucrose, mannitol and combinations thereof.

In one preferred aspect the salt is selected from the group consisting of baking powder, ammonium carbonate, sodium chloride, and combinations thereof.

### Particle Size

As discussed herein the water soluble particulate material has an average particle size of from 10 to 1000 μm. The term “average particle size” as used herein may refer to the D[4,3]—Volume or Mass Moment Mean, also called the De Brouckere Mean Diameter. This size may be measured on a Malvern Mastersizer. In respect of sugars, the term “average particle size” as used herein may refer to particle size as determined by the following method: The Determination of the Particle Size Distribution of White Sugar and Plantation White Sugar by Sieving by ICUMSA (International Commission for Uniform Methods of Sugar Analysis) Method GS 2/9-37 (2007).

In one aspect the water soluble particulate material has an average particle size of from 10 to 950 μm, such as 10 to 900 μm, such as 10 to 850 μm, such as 10 to 800 μm, such as 50 to 800 μm, such as 10 to 750 μm, such as 10 to 700 μm, such as 10 to 650 μm, such as 10 to 600 μm, such as 10 to 550 μm, such as 10 to 500 μm, such as 10 to 450 μm, such as 10 to 400 μm, such as 10 to 350 μm, such as 10 to 300 μm, such as 10 to 250 μm, such as 10 to 200 μm, such as 10 to 150 μm, such as 10 to 100 μm, such as 10 to 90 μm, such as 10 to 80 μm, such as 10 to 70 μm, such as 10 to 60 μm, such as 10 to 50 μm.

In one aspect the water soluble particulate material is selected from sucrose and mannitol and has an average particle size of from 10 to 950 μm, such as 10 to 900 μm, such as 10 to 850 μm, such as 10 to 800 μm, such as 50 to 800 μm, such as 10 to 750 μm, such as 10 to 700 μm, such as 10 to 650 μm, such as 10 to 600 μm, such as 10 to 550 μm, such as 10 to 500 μm, such as 10 to 450 μm, such as 10 to 400 μm, such as 10 to 350 μm, such as 10 to 300 μm, such as 10 to 250 μm, such as 10 to 200 μm, such as 10 to 150 μm, such as 10 to 100 μm, such as 10 to 90 μm, such as 10 to 80 μm, such as 10 to 70 μm, such as 10 to 60 μm, such as 10 to 50 μm.

In one aspect the water soluble particulate material is sucrose and has an average particle size of from 10 to 950 μm, such as 10 to 900 μm, such as 10 to 850 μm, such as 10 to 800 μm, such as 50 to 800 μm, such as 10 to 750 μm, such as 10 to 700 μm, such as 10 to 650 μm, such as 10 to 600 μm, such as 10 to 550 μm, such as 10 to 500 μm, such as 10 to 450 μm, such as 10 to 400 μm, such as 10 to 350 μm, such as 10 to 300 μm, such as 10 to 250 μm, such as 10 to 200 μm, such as 10 to 150 μm, such as 10 to 100 μm, such as 10 to 90 μm, such as 10 to 80 μm, such as 10 to 70 μm, such as 10 to 60 μm, such as 10 to 50 μm.

### Amount

The food ingredient and water soluble particulate material may be present in any suitable amounts to provide the desired function of the present invention.

In one aspect the food ingredient is present in an amount of at least 1 wt. %, such as in an amount of at least 2 wt. %, such as in an amount of at least 5 wt. %, such as in an amount of at least 10 wt. %, such as in an amount of at least 15 wt. %, such as in an amount of at least 20 wt. %, such as in an amount of at least 25 wt. %, such as in an amount of at least 30 wt. %, such as in an amount of at least 35 wt. %, such as in an amount of at least 40 wt. %, such as in an amount of at least 45 wt. %, such as in an amount of at least 50 wt. %, such as in an amount of at least 55 wt. %, such as in an amount of at least 60 wt. %, such as in an amount of at least 65 wt. %, such as in an amount of at least 70 wt. %, such as in an amount of at least 75 wt. %, such as in an amount of at least 80 wt. %, such as in an amount of at least 85 wt. %, such as in an amount of at least 85 wt. %, such as in an amount of at least 90 wt. %, based on the weight of the composition.

In one aspect the food ingredient is an emulsifier and the emulsifier is present in an amount of at least 1 wt. %, such as in an amount of at least 2 wt. %, such as in an amount of at least 5 wt. %, such as in an amount of at least 10 wt. %, such as in an amount of at least 15 wt. %, such as in an amount of at least 20 wt. %, such as in an amount of at least 25 wt. %, such as in an amount of at least 30 wt. %, such as in an amount of at least 35 wt. %, such as in an amount of at least 40 wt. %, such as in an amount of at least 45 wt. %, such as in an amount of at least 50 wt. %, such as in an amount of at least 55 wt. %, such as in an amount of at least 60 wt. %, such as in an amount of at least 65 wt. %, such as in an amount of at least 70 wt. %, such as in an amount of at least 75 wt. %, such as in an amount of at least 80 wt. %, such as in an amount of at least 85 wt. %, such as in an amount of at least 85 wt. %, such as in an amount of at least 90 wt. %, based on the weight of the composition.

In one aspect the water soluble particulate material is present in an amount of no greater than 90 wt. %, such as in an amount of no greater than 80 wt. %, such as in an amount of no greater than 70 wt. %, such as in an amount of no greater than 60 wt. %, such as in an amount of no greater than 50 wt. %, such as in an amount of no greater than 45 wt. %, such as in an amount of no greater than 40 wt. %, such as in an amount of no greater than 35 wt. %, such as in an amount of no greater than 30 wt. %, such as in an amount of no greater than 25 wt. %, such as in an amount of no greater than 20 wt. %, such as in an amount of no greater than 15 wt. %, such as in an amount of no greater than 10 wt. %, based on the weight of the composition.

Preferred ratios of food ingredient to water soluble particulate material include from 10:1 to 1:5, such as from 9:1 to 1:5, such as from 8:1 to 1:5, such as from 7:1 to 1:5, such as from 6:1 to 1:5, such as from 5:1 to 1:5, such as from 5:1 to 1:4, such as from 5:1 to 1:3, such as from 5:1 to 1:2, such as from 5:1 to 1:1, such as from 5:1 to 2:1, such as from 5:1 to 3:1, such as from 5:1 to 1:5, such as from 5:1 to 1:5, based on weight.

As discussed in the present examples, we have identified that an optimum hydration speed of a food ingredient, such as an emulsifier, has been found in products which contain in the area of 30-40% water soluble particulate material (in the case of icing sugar with an average particle size of 50 μm or below). Less water soluble particulate material will decrease the speed of hydration and higher amounts may not add further to the speed of hydration. However it has to be mentioned that an increased amount of water soluble particulate material (>40%) does not negatively influence the performance of the product as long as the use of the final product is made based on the amount of emulsifier.

### Additional Components

The composition of the present invention may contain one or more further components. These components may have an effect on the hydration of the food ingredient or may be additional food ingredients which do not have a material effect on hydration. In one aspect the composition further comprises (c) a disintegrant. The disintegrant may be selected from hydrocolloids, proteins, edible fibres and combinations thereof. The disintegrant may be selected from hydrocolloids, edible fibres and combinations thereof. More specifically, the disintegrant may be selected from cellulose, carboxymethyl cellulose, sugar beet fibre and combinations thereof.

The hydrocolloids may be selected from alginate, carrageenan, carboxymethyl cellulose (CMC), guar gum, locust bean gum (LBG), xanthan gum, microcrystalline cellulose (MCC), methyl cellulose (MC), cellulose ethers including hydroxy propyl methyl cellulose (HPMC), pectin, starch including native and modified starch, pregelatinated starch and non-pregelatinated starch, including starch from corn, potato, tapioca, wheat, and rice, gelatin, agar, and combinations thereof.

The proteins may be selected from milk proteins, wheat proteins, pea proteins, soy proteins, buckwheat proteins, carob proteins, barley proteins, oat proteins, rice proteins, rye proteins, gelatin, whey proteins, and combinations thereof.

Preferably the disintegrant is an edible fibre.

In one aspect the composition further comprises (c) an edible fibre in an amount of no greater than 30 wt %, such as an amount of no greater than 25 wt %, such as an amount of no greater than 20 wt %, such as an amount of no greater than 15 wt %, such as an amount of no greater than 10 wt %, such as in an amount of no greater than 9 wt %, such as an amount of no greater than 8 wt %, such as an amount of no greater than 7 wt %, such as an amount of no greater than 6 wt %, such as an amount of no greater than 5 wt %, such as based on the weight of the composition.

The term edible fibre includes polysaccharides, oligosaccharides, lignin and associated plant substances.

Preferably the edible fibre is selected from sugar beet fibre, apple fibre, pea fibre, wheat fibre, oat fibre, barley fibre, rye fibre, rice fibre, potato fibre, tomato fibre, other plant non-starch polysaccharide fibres, and combinations thereof.

More preferably the edible fibre comprises at least sugar beet fibre.

The term “edible fibre” is commonly used in the art and is analogous to the term “dietary fibre”. By the term “edible fibre” it is meant the edible parts of plants, or analogous carbohydrates, that are resistant to digestion and absorption in the human small intestine with complete or partial fermentation in the large intestine. This is the consensus definition of the American Association of Cereal Chemists (AACC) Dietary Fibre Definition Committee.

In one aspect the disintegrant may be selected from macromolecules such as hydrocolloids, cellulose gums, proteins, dietary fibres, alginic acids (alginate), amylose, arabinogalactans, chitosan, chondroitin sulfate, cyclodextrin, dextran, galactomannans, gellan gum, konjac, guar gum, inulin, polydextrose, karaya gum, laminarin, locust bean gum, pectins, pullulan, rice bran, scleroglucan, tragacanth, wheat starch, xanthan, cross-linked polyacrylic acid, polyvinyl alcohol, polyvinyl pyrrolidone, carboxymethylcellulose, methyl cellulose, hydroxymethyl cellulose, hydroxyethyl cellulose, hydroxypropyl cellulose, hydroxypropyl methylcellulose, polyethylene oxide, cellulose, starch, superporous hydrogels, polyacrylamide, polyisopropyl acrylamide, crosslinked starch, cross-linked hyaluronic and other types of polymers. Each of these materials may assist in the disintegration of the composition and may be regarded as disintegrants. It is also within the scope of the invention to use mixtures of these disintegrants. The disintegrants are preferably used in concentrations ranging from 2.5 to 20 wt % based on the total composition. However, both smaller and higher amounts of disintegrants are expected to have an effect as well. In a highly preferred aspect the disintegrants are used in a concentration of approximately 10 wt % based on the weight of the total composition.

The disintegrant may be incorporated in the initial composition and spray crystallised with the composition or may be added after spray crystallisation.

In one aspect the composition further comprises an enzyme. The enzyme may be any known enzyme. In particular, the composition may include an enzyme known in the field of bakery or baked products. A preferred enzyme for use in bakery or baked products is an enzyme which can reduce or inhibit staling or which can promote softness in a bakery or baked product.

### Composition

Preferably the food ingredient and the water soluble particulate material are spray crystallised to prepare the present composition such that the food ingredient and the water soluble particulate material are integrated with each other. Thus in one aspect the present invention provides a composition comprising (a) a food ingredient, the hydration of which is to be enhanced; (b) a water soluble particulate material, having an average particle size of from 10 to 1000 μm; wherein the food ingredient and the sugar or sugar alcohol are spray crystallised such that the food ingredient and the water soluble particulate material are integrated with each other.

Preferably the composition of the present invention or the initial composition of the process of the present invention is substantially free of free water.

By the term “free water” it is meant water which is not incorporated within one of the constituents of the initial composition. This is not free water.

By the term “substantially free of free water” it is meant having a free water content of preferably less than 20 wt %, preferably less than 15 wt %, preferably less than 10 wt %, preferably less than 5 wt %, preferably less than 2 wt %, more preferably less than 1 wt %, more preferably less than 0.5 wt %, yet more preferably less than 0.1 wt %.

In contrast to the present invention spray drying of compositions is always performed in the presence of free water, for example a free water content of 40-98 wt %.

The composition of the present invention may be used in the preparation of a variety of foodstuffs. Foodstuffs include bakery products prepared from bakery batters such as cake batters and whipping systems such as toppings, creams, ice creams, and mousses.

The composition of the present invention may be in the form of a free-flowing non-dusty powder which consists of small uniform beads. The flowability of the composition may be improved by the addition of anti-caking agent. The emulsifier part imparts a good whipability to the batter.

It is to be appreciated that the product obtainable and/or obtained by the process of the present invention is encompassed by the present invention. Accordingly in further aspects the present invention provides
a composition obtainable by the process of the present invention
a composition obtained by the process of the present invention

The composition of the present invention may be used in the preparation of any number of products, in particular food products such as bakery foodstuffs and whipped foodstuffs. Thus in further aspects, the present invention provides
a bakery product comprising or prepared from a composition of the present invention.
a whipped foodstuff comprising or prepared from a composition of the present invention.

The invention will now be described, by way of example only, with reference to the following Examples.

### EXAMPLES

In this work we identified an improved version of the existing GRINDSTED® GA1350 available from DuPont (formerly Danisco NS). In particular we improved the functionality of GRINDSTED® GA1350 by improving the speed of hydration. In the current work a sugar or sugar alcohol is fully integrated with the emulsifier in a uniform matrix and evenly distributed both inside and on the surface of the products. The products investigated are spray crystallised powders.

### Erosion-Controlled Hydration of Emulsifiers

All comparisons in the current work have been based on the use of equal amounts of emulsifiers. This means that an increased amount of sugar also relates to an increase in the amount of product needed in the recipes. The products have been tested in a low fat sponge cake recipe and in a concentration of 1% of emulsifier. Since the new cake emulsifiers contain between 2.5% to 60% of “non emulsifiers” such as sugars etc. they have been tested in concentrations between 1.0 and 2.5% in the cake recipes.

### Disintegrants

As described above the erosion model provides improvement of the effect of the emulsifier in both whipping and baking tests. This effect has been further enhanced by the incorporation of disintegrants into the emulsifier product. It is understood that the disintegrant that is incorporated in the whole matrix, both inside and on the surface, swells when it gets in contact with water. The forces in the swelling process are so strong, that they are able to burst the particles open and thereby increase the surface area the emulsifier. Several swelling products have been tested both from the pharmaceutical and the food industry. Characteristic for the swelling agents are that they can be categorized as either natural polysaccharides or (semi) synthetic polymers.

It can be seen in FIG. 3 that the addition of disintegrants improve the whipping speed and final whipping density of the batter. It can be further seen that the effect of combining the two technologies, erosion and disintegration, improves the effect even further.

The following ingredients have been tested for their disintegrant properties:
Solka-Floc® 900 FCC—powdered cellulose
Disolcel®—cross-linked sodium carboxymethyl cellulose (CMC)
GRINDSTED® CG BEV 130—a highly purified (purity min. 99.5%) sodium carboxymethylcellulose
GRINDSTED® CG BAK 020—a highly purified (purity min. 99.5%) sodium carboxymethylcellulose
GRINDSTED® CG BAK 130—a highly purified (purity min. 99.5%) sodium carboxymethylcellulose
GRINDSTED® CMC 1250—carboxymethyl cellulose (CMC)
Fibrex® 595 DC—sugar beet fibres with a particle size <0.125 mm
Fibrex® 575—sugar beet fibres with a particle size <0.032 mm

Solca-Floc 900 FCC is a product of ifc (International Fiber Corporation), New York. Disocel is a product of Mingtai Chemical Co, Taiwan. GRINDSTED® CG BEV 130, GRINDSTED® CG BAK 020, GRINDSTED® CG BAK 130, GRINDSTED® CMC 1250, Fibrex® 595 DC, Fibrex® 575 are all products of DuPont, Denmark.

A number of combinations of 10% disintegrant and 10-50% sugar have been tested. One high performing combination consists of 20% sugar and 10% Fibrex.

Whipping performance has been tested in both in low shear and high shear cake applications. The low shear results are targeted products that will be used in consumer products such as cake mixes. These have been tested using a Hobart mixer. For industrial use a high shear process have been used. The high shear products have been tested using a Hansa Mixer with injection of air. The two types of processes have different requirements to their ability the hydrate. Therefore it is not the same products that perform best in low shear and high shear processes. In low shear processes the addition of only water soluble particulate materials seems to perform nearly equally well as combinations of both water soluble particulate materials and disintegrants. In high shear processes in contrast the combination of the two types of ingredients seems to perform markedly better.

### Materials & Methods:

1. Sponge Cake recipe—Reference no APB 23.8310.1.9
2. Mixing procedure using Hobart N50 Mixer.
3. Mixing procedure using Hansa Mixer top Mix-K 40113.
4. Whipping profile using Hobart N50 Mixer
5. Spray crystallization

### 1. Sponge Cake Recipe—Reference No APB 23.8310.1.9

| Ingredients | % |
|---|---|
| DanSukker 35/20, Nordic Sugar | 24.7 |
| Albatros Cake Flour, Meneba | 22.4 |
| Naitive Waxy Maize Starch BB0370, Cargill | 7.1 |
| Baking powder, BPHS 003, Budenheim | 1.7 |
| Liquid whole egg, pasteurised, Dan [symbol] Eg | 23.8 |
| Water | 19.3 |
| Powder emulsifier, “active emulsifier” | 1.00 |
| Total | 100.0 |

### 2. Mixing Procedure Using Hobart N50 Mixer

| Ingredients | g |
|---|---|
| DanSukker 35/20, Nordic Sugar | 247.0 |
| Albatros Cake Flour, Meneba | 224.0 |
| Naitive Waxy Maize Starch BB0370, Cargill | 71.0 |
| Baking powder, BPHS 003, Budenheim | 17.0 |
| Liquid whole egg, pasteurised, Dan [symbol] Eg | 238.0 |
| Water | 193.0 |
| Powder emulsifier, “active emulsifier” | 10.0 |
| Total | 1000.0 |

### Equipment:

Mixer: Hobart N50+whisk—supplier: Hobart Corporation, USA
Oven: Simon Rotary Test Oven—supplier: Henry Simon Ltd., England
Volume Measurer: TexVol BVM-L 370—supplier TexVol Instruments, Sweden.

### Procedure:

All ingredients must be tempered to room temperature (20° C.)
1. Add all dry ingredients into the bowl of the Hobart N50 Mixer
2. Add liquids while mixing, using 1^{st} speed.
3. Mix 10 minutes using 3^{rd} speed.
4. Take out batter for measuring the batter density (g/l) using a 1 dl cup.
5. Scale 2×350 g into round sponge cake tins, diameter 22 cm (The tins must be greased).
6. Bake the cakes for 30 min. at 180° C.
7. Take the cakes out of the tins and leave to cool for minimum 40 minutes before measuring the volume on the Tex-Vol.

### 3. Mixing Procedure Using Hansa Mixer Top Mix-K 40113:

| Ingredients | g |
|---|---|
| DanSukker 35/20, Nordic Sugar | 1729.0 |
| Albatros Cake Flour, Meneba | 1568.0 |
| Naitive Waxy Maize Starch BB0370, Cargill | 497.0 |
| Baking powder, BPHS 003, Budenheim | 119.0 |
| Liquid whole egg, pasteurised, Dan [symbol] Eg | 1666.0 |
| Water | 1351.0 |
| Powder emulsifier, “active emulsifier” | 70.0 |
| Total | 7000.0 |

### Equipment:

### Mixers:

Hobart A200+paddle—supplier: Hobart Corporation, USA.
Hansa Mixer, Top Mix-K 40113—supplier: Hansa Industrie Mixer, Germany
Oven: Simon Rotary Test Oven—supplier: Henry Simon Ltd., England.
Volume Measurer: TexVol BVM-L 370—supplier TexVol Instruments, Sweden.

### Procedure:

All ingredients must be tempered to room temperature. (20° C.)

The Hansa Mixer is prepared for operation with the following settings:
FW.: 200
PU.: 301/hour
MH.: 250 rpm.
Flow rate: 2.1 bar
Pre pressure: 7 bar
Back pressure: 2 bar

Turn on the water and the air pressure hose.

Start the system by turning the bottoms “MH” and “PU”.
1. Add all dry ingredients into the bowl of the Hobart A200 Mixer.
2. Add liquids while mixing, using 1^{st} speed.
3. Mix for 3 min. in 1^{st} speed.
4. Add half of the premix batter into the hopper of the Hansa Mixer.
5. Start the Hansa Mixer according to the above settings.
6. Double check the settings to secure the right settings.
7. Add the rest of the premix.
8. Run the Hansa Mixer for 4 minutes. Take out batter for measuring the batter density (g/l), using a 1 dl cup.
9. Scale 2×350 g into round sponge cake tins, diameter 22 cm. (The tins must be greased).
10. Bake the cakes for 30 min. at 180° C.
11. Take the cakes out of the tins and leave to cool for minimum 40 minutes before measuring the volume on the Tex-Vol.

### 4. Whipping Profile Using Hobart N50 Mixer

| Ingredients | g |
|---|---|
| DanSukker 35/20, Nordic Sugar | 247.0 |
| Albatros Cake Flour, Meneba | 224.0 |
| Naitive Waxy Maize Starch BB0370, Cargill | 71.0 |
| Baking powder, BPHS 003, Budenheim | 17.0 |
| Liquid whole egg, pasteurised, Dan [symbol] Eg | 238.0 |
| Water | 193.0 |
| Powder emulsifier, “active emulsifier” | 10.0 |
| Total | 1000.0 |

### Equipment:

Mixer: Hobart N50+whisk—supplier: Hobart Corporation, USA

### Procedure:

All ingredients must be tempered to room temperature (20° C.)
1. Add all dry ingredients into the bowl of the Hobart N50 Mixer.
2. Add liquids while mixing, using 1^{st} speed.
3. Mix exactly 2 minutes using 3^{rd} speed.
4. Take out batter for measuring the batter density (g/l) using a 1 dl cup.
5. Scrape the batter back into the mixing bowl.
6. Repeat point 3 to 5 measuring the batter densities after 2, 4, 6, 8, 10 and 12 minutes of whipping using 3^{rd} speed.

### 5. Spray Crystallization

The samples are prepared as an easy flowing powder by spray crystallization. The spray crystallization has been made on a NIRO NP 6.3 spray unit. The spray tower is 1.6 m in diameter, 2.0 m in total height and 1.2 m in conus height. The spray tower uses a spray wheel (atomizer wheel) that is 120 mm in diameter. After spraying the samples are collected in a cyclone system (0.38 m diameter, 1.05 m total height, 0.73 m conus height). The production capacity of the spray tower is 5-20 kg/h. Selected products have been produced on a full size industrial scale spray tower. No differences in functionality of the produced products were observed by up-scaling to industrial scale.

### Example 1

### Study of Sugar Concentration

GRINDSTED® GA1350 available from DuPont (formerly Danisco NS) and consisting of a mixture of emulsifiers, namely distilled monoglyceride (DMG), and propylene glycol monostearate (PGMS) in a combined amount of at least 75 wt % and sodium stearoyl lactylate (SSL) in an amount of 10-20 wt % was melted and mixed with icing sugar (sucrose, particle size app. 50 μm) in weight ratios of 50/50, 60/40, 70/30, 80/20 and 90/10 (emulsifier/sugar). The samples were spray crystallised giving a particle size of app. 75-200 μm. The whipping performance of the samples was evaluated in a sponge cake recipe as described above and in both a low shear and a high shear process according to the above descriptions. The batter density of the samples was measured repeatedly in two minutes intervals from 2 to 12 minutes. The products ability to incorporate air into the sample, measured by the batter density, was evaluated. The sample that contained 50/50 showed an improved performance (ability to incorporate air) compared to a references sample of the same emulsifier combination but without the sugar. The improvement was in the order of 10%. The sample containing 60/40 showed an improvement of 70%, 70/30 of 65%, 80/20 of 60% and 90/10 of 40%. All samples were compared in a baking recipe as described above in a concentration where the whipping emulsifier content was kept constant at 1%. All samples showed a good baking performance according to the above described criteria.

### Example 2

### Study of Sugar Particle Size

An emulsifier combination as described in Example 1 (GRINDSTED® GA1350) was melted and mixed with sugar (sucrose) of different particle sizes. The different mixtures contained 70 wt % emulsifier and 30 wt % of the relevant sugar. The sugar was tested in a range between 50 and 800 μm. The sugar products were: icing sugar (50 μm), milled sugar (100 μm), granulated sugar (<250 μm), caster sugar (250-400 μm) and standard sugar (800 μm). The numbers in parentheses are average particle sizes. The products were spray cooled/crystallised giving a particle size of app. 100-200 μm. The whipping properties of the samples were evaluated according to the procedure described in Example 1. The sample that contained icing sugar had a whipping performance that was 65% better than a similar sample without sugar. Milled sugar showed an improvement of 45%, granulated sugar 35%, caster sugar 20% and standard sugar 5%. This clearly shows the influence of the particle size on the product performance. The smaller the sugar particles the better whipping performance is seen. All samples showed a good baking performance according to the above described criteria.

### Example 3

### Study of Sugar Types

An emulsifier combination as described in Example 1 (GRINDSTED® GA1350) was melted and mixed with sugar/sweetener of different types The different mixtures contained 70 wt. % emulsifier and 30 wt. % of the relevant sugar/sweetener. The sugars were sucrose products having average particle sizes of 50, 100, 200, 250-400 and 800 μm and mannitol. The mannitol products tested were

PEARLITOL® 100SD—a mannitol having an average particle size of 100 μm and mainly containing alpha-form of mannitol,
PEARLITOL® 200SD—a mannitol having an average particle size of 180 μm and mainly containing alpha-form of mannitol,
PEARLITOL® 50C—a mannitol having an average particle size of 50 μm and mainly containing beta-form of mannitol, and
PEARLITOL® 160C—a mannitol having an average particle size of 160 μm and mainly containing beta-form of mannitol.
PEARLITOL® 100SD, 200SD, 50C and 160C are all available from DuPont (formerly Danisco A/S). The products were spray cooled/crystallised giving a particle size of app. 100-200 μm. The whipping properties of the samples were evaluated according to the procedure described in Example 1. The sample that contained PEARLITOL® 100SD had whipping performance that was 35% better than a similar sample without sugar. PEARLITOL® 200SD showed an improvement of 12%, PEARLITOL® 50C 25% and PEARLITOL® 160C 20%. This clearly shows other types of sugars and sugar alcohols can improve the whipping performance of cake emulsifiers. The smaller the sugar particles the better whipping performance is seen. All samples showed a good baking performance according to the above described criteria.

### Example 4

### Study of Disintegrant Concentration and Types

An emulsifier combination as described in Example 1 (GRINDSTED® GA1350) was melted and mixed with disintegrants of different types. The different mixtures each contained two combinations 80 wt. %/20 wt. % and 90 qt. %/10 qt. % of emulsifier/relevant disintegrant. The disintegrants were Solka-Floc® 900 FCC (powdered cellulose) and NutraFiber® WWF40 (powdered cellulose) available from IFC (International Fibre Corporation—USA), Disolcel® GF (cross-linked sodium carboxymethyl cellulose (CMC)) from Mingtai Chemical Co. Ldt in Denmark, GRINDSTED® CG BEV 130, GRINDSTED® CG BAK 020, GRINDSTED® CG BAK 130, GRINDSTED® CMC 1250 all available from DuPont (formerly Danisco A/S) and Fibrex® 595 DC (sugar beet fibre with a particle size <125 μm), Fibrex® 575 (sugar beet fibre with a particle size <32 μm) (Both Fibrex® types were available from Nordic Sugar Denmark). The products were spray cooled/crystallised giving a particle size of app. 100-200 μm. The whipping properties of the samples were evaluated according to the procedure described in Example 1.

The sample that contained Solka-Floc® 900 FCC (80/20) had a whipping performance that was 5% better than a similar sample without sugar and the (90/10) showed 10% improvement. The sample that contained NutraFiber® WWF40 (80/20) had a whipping performance that was 5% better than a similar sample without sugar and the (90/10) showed 10% improvement. The sample that contained Disolcel® GF (80/20) had a whipping performance that was 14 better than a similar sample without sugar and the (90/10) showed 8% improvement. The sample that contained GRINDSTED® CG BEV 130 (80/20) had a whipping performance that was 23% better than a similar sample without sugar and the (90/10) showed 25% improvement. The sample that contained GRINDSTED® CG BAK 020 (80/20) had a whipping performance that was 24% better than a similar sample without sugar and the (90/10) showed 29% improvement. The sample that contained GRINDSTED® CG BAK 130 (80/20) had a whipping performance that was 27% better than a similar sample without sugar and the (90/10) showed 29% improvement. The sample that contained Fibrex® 595 DC (80/20) had whipping performance that was 11% better than a similar sample without sugar and the (90/10) 12% improvement. The sample that contained GRINDSTED® CMC 1250 (80/20) had a whipping performance that was 30% better than a similar sample without sugar and the (90/10) showed 35% improvement. The sample that contained Maltodextrin DE20 (70/30) had a whipping performance that was 35% better than a similar sample without sugar. All samples were compared in a baking recipe as described above in a concentration where the whipping emulsifier content was kept constant at 1%. All samples showed a good baking performance according to the above described criteria.

### Example 5

### Study of Combinations of Disintegrants and Sugars

An emulsifier combination as described in Example 1 (GRINDSTED® GA1350) was melted and mixed with sucrose in the form of icing sugar (50 μm). The combinations were varied according to the below scheme: (the improvement is shown in the last column)

| | | | | | Whipping |
|---|---|---|---|---|---|
| | Icing | | | | Improve- |
| Emulsifier | Sugar | | CK BAK | Disolcel ® | ment |
| (wt %) | (wt %) | Fibrex 595 | 130 (wt %) | (wt %) | (%) |
| 50 | 50 | | | | 20 |
| 60 | 40 | | | | 71 |
| 70 | 30 | | | | 66 |
| 80 | 20 | | | | 64 |
| 50 | 40 | 10 | | | 50 |
| 60 | 30 | 10 | | | 67 |
| 70 | 20 | 10 | | | 35 |
| 80 | 10 | 10 | | | 29 |
| 55 | 40 | 5 | | | 60 |
| 65 | 30 | 5 | | | 53 |
| 75 | 20 | 5 | | | 27 |
| 85 | 10 | 5 | | | 36 |
| 57.5 | 40 | 2.5 | | | 54 |
| 67.5 | 30 | 2.5 | | | 47 |
| 77.5 | 20 | 2.5 | | | 43 |
| 87.5 | 10 | 2.5 | | | 28 |
| 50 | 40 | | 10 | | 30 |
| 60 | 30 | | 10 | | 20 |
| 70 | 20 | | 10 | | 32 |
| 80 | 10 | | 10 | | 52 |
| 55 | 40 | | 5 | | 7 |
| 65 | 30 | | 5 | | 37 |
| 75 | 20 | | 5 | | 42 |
| 85 | 10 | | 5 | | 49 |
| 57.5 | 40 | | 2.5 | | 35 |
| 67.5 | 30 | | 2.5 | | 40 |
| 77.5 | 20 | | 2.5 | | 38 |
| 87.5 | 10 | | 2.5 | | 35 |
| 60 | 30 | | | 10 | 70 |

The tested samples showed an effect of combining both water soluble particulate materials and disintegrants. The effects of the combinations are better or equal compared to products where the water soluble particulate materials or disintegrants are used separately. The combination of 60% emulsifier, 30% icing sugar and 10% Disolcel had a whipping performance that was 70% better than a similar emulsifier without water soluble particulate materials and disintegrants. The sample that contained 57.5% Emulsifier, 40% icing sugar and 2.5% Fibrex 595 showed an improvement of 54%. The sample that contained 85% emulsifier, 10% icing sugar and 5% CG BAK 130 showed an improvement of 49%.

### Example 6

### Study of Particle Size of Disintegrants

70 wt. % of an emulsifier combination as described in Example 1 (GRINDSTED® GA1350) was melted and mixed with 20 wt. % Icing sugar and 10 wt. % Fibrex. Fibrex was tested in two different particle sizes. Fibrex was supplied from Nordic Sugar. Fibrex 595 is having a particle size of <125 μm and Fibrex 575 is having a particle size <32 μm. In the low shear whipping test the sample that contained Fibrex 595 showed an improved whipping performance of 35% whereas the sample that contained Fibrex 575 showed an improvement of 55%.

### Example 7

### Study of High Shear Mixing

An emulsifier combination as described in Example 1 (GRINDSTED® GA1350) and mixed according to:

70 wt. % GA1350+30 wt. % icing sugar
70 wt. % GA1350+20 wt. % icing sugar+10 wt. % Fibrex 595
70 wt. % GA1350+20 wt. % icing sugar+10 wt. % CMC1250

The samples were tested on a high shear Hansa mixer according to the method described in process no. 3. The whipping properties of the samples show improvements compared to a sample without icing sugar, Fibrex 595 ore Grindsted CMC1250. The sample that contained 30% icing sugar showed an improvement in whipping performance of 25%, the sample that contained 20% icing sugar and 10% Fibrex 595 showed an improvement of 40% and the sample that contained 20% icing sugar and 10% Grindsted CMC1250 showed an improvement of 15%.

### Example 8

### Study of High Ratio Fat Cakes

Use of an “all-in” mixing procedure was tested, where all ingredients were blended as a mix, then water was added in stages. These powdered-egg formulations were tested with shortening and oil as fat sources.

The following active emulsifier combinations were tested:

### GA1350: 100 wt. % GRINDSTED® GA1350

### PCE1: 70 wt. % GA1350+30 wt. % Icing Sugar

### PGE2: 70 wt. % GA1350+20 wt. % Icing Sugar+10 wt. % Fibrex 595

### PCE3: 70 wt. % GA1350+20 wt. % Icing Sugar+10 wt. % GRINDSTED CMC 1250

Cake batters were analyzed for specific gravity and viscosity prior to baking. A Bostwick Consistometer (CSC Scientific, Fairfax, Va.) was used for viscosity/flow characteristic testing, and measurements were taken at 10 and 30 seconds.

Cakes were analyzed for specific volume using a TexVol BVM-L370 Volume Measuring Device (Perten Instruments, Viken, Sweden). Additionally, template volume was recorded using AACC Method 10-91 for measuring Volume Index.

Formulas adjusted with sugar to deliver same emulsifier dosage for all test samples.

| | Shortening | Oil | |
|---|---|---|---|
| | Formula | Formula | |
| Ingredient | % | % | Supplier |
| Granulated | 27.14% | 27.14% | Sysco, |
| Sugar | | | Houston, TX |
| All Purpose | 8.30% | 0% | Sysco, |
| Shortening | | | Houston, TX |
| Active | 0.75% | 0.75% | Variable, see |
| Emulsifier | | | below |
| High Ratio | 22.62% | 22.62% | General Mills, |
| Cake Flour | | | Minneapolis, MN |
| Dried Whole | 3.39% | 3.39% | Sonstegard Foods, |
| Egg Solids | | | Sioux Falls, SD |
| Nonfat Dried | 1.81% | 1.81% | Franklin Farms |
| Milk Solids | | | East, Asbury, NJ |
| Dried Egg | 1.13% | 1.13% | Wakefield Farms - |
| White Solids | | | Michael Foods, |
| | | | Minnetonka, MN |
| Salt | 0.79% | 0.79% | Cargill, |
| | | | Minneapolis, MN |
| Instant Clearjel | 0.68% | 0.68% | National Starch, |
| Modified Starch | | | Bridgewater, NJ |
| Danisco CMC | 0.05% | 0.05% | DuPont Nutrition |
| BAK 130 | | | & Health, New |
| | | | Century, KS |
| Danisco | 0.06% | 0.06% | DuPont Nutrition |
| Xanthan 80 | | | & Health, New |
| | | | Century, KS |
| Sodium | 0.57% | 0.57% | Sysco, |
| Bicarbonate | | | Houston, TX |
| SALP | 0.15% | 0.15% | Buddenheim, |
| | | | Columbus, OH |
| SAS | 0.29% | 0.29% | Buddenheim, |
| | | | Columbus, OH |
| Sorbic Acid | 0.03% | 0.03% | APAC Chemical, |
| | | | Arcadia, CA |
| Soybean Oil | 0% | 8.30% | Columbus |
| | | | Vegetable Oils, |
| | | | Des Plaines, IL |
| Water | 32.26% | 32.26% | Tap |
| | 100.00% | 100.00% | |

Shortening Based Cake Processing and Evaluation. Base mix recipe and procedure using Hobart N50 Mixer and Cuisinart DLC-X Plus Food Processor.

| | Shortening Formula |
|---|---|
| Ingredient | Grams |
| Granulated Sugar | 400.6 |
| All Purpose Shortening | 122.5 |
| Active Emulsifier | 11.0 |
| High Ratio Cake Flour | 333.9 |
| Dried Whole Egg Solids | 50.1 |
| Nonfat Dried Milk Solids | 26.7 |
| Dried Egg White Solids | 16.7 |
| Salt | 11.7 |
| Instant Clearjel Modified Starch | 10.0 |
| Danisco CMC BAK 130 | 0.7 |
| Danisco Xanthan 80 | 0.8 |
| Sodium Bicarbonate | 8.3 |
| SALP | 2.2 |
| SAS | 4.2 |
| Sorbic Acid | 0.5 |
| | 1000.0 |

### Equipment:

### Hobart N50 Mixer, Hobart-Troy, Ohio

### Panasonic Microwave Oven NN-T9945F, Panasonic—Secaucus, N.J.

### Cuisinart DLC-X Plus Food Processor, Cuisinart-East Windsor, N.J.

Procedure for Shortening Based Mix
1. Blend minor ingredients (Whole Egg, Nonfat Dried Milk, Egg White, Salt, Clearjel Starch, CMC, Xanthan 80, Sodium Bicarbonate, SALP, Sorbic Acid, SAS) in Hobart mixer bowl for 5 minutes. Set aside.
2. Melt shortening to liquid state in microwave oven.
3. In separate mixer bowl, add sugar. Slowly add melted shortening to mixer while running for 1 minute on LOW speed. Blend for 1 minute on LOW speed.
4. Add minors and flour to mixer. Blend for 3 minutes on LOW speed.
5. Transfer contents of mixer bowl to food processor bowl and seal.
6. While running for 1 minute, add emulsifier.
7. Scrape food processor bowl thoroughly, and mix for 1 additional minute.
8. Package mix and store until use.

### Cake Mixing Formula and Procedures:

| | Shortening |
|---|---|
| Batter | Grams |
| Dry Mix | 812.9 |
| Dry Mix (No Shortening) | 0 |
| Water | 387.1 |
| Oil | 0 |
| Total | 1200 |

### Equipment:

### Hobart N50 Mixer, Hobart—Troy, Ohio

### Reed Oven, Reed Oven Company—Kansas City, Mo.

Procedure for Shortening Based Cakes
1. Add dry mix to mixer.
2. Add 40% of water to mixer (155 g).
3. Mix 2 min LOW, SCRAPE, Mix 1.5 min MEDIUM.
4. Add remainder of water (232.1 g).
5. Mix 1.5 min LOW, SCRAPE, Mix 1.5 min LOW.
6. Scale at 425 g
7. Bake 27 to 28 min at 365° F.
   Data from Analysis—Shortening Based Cakes

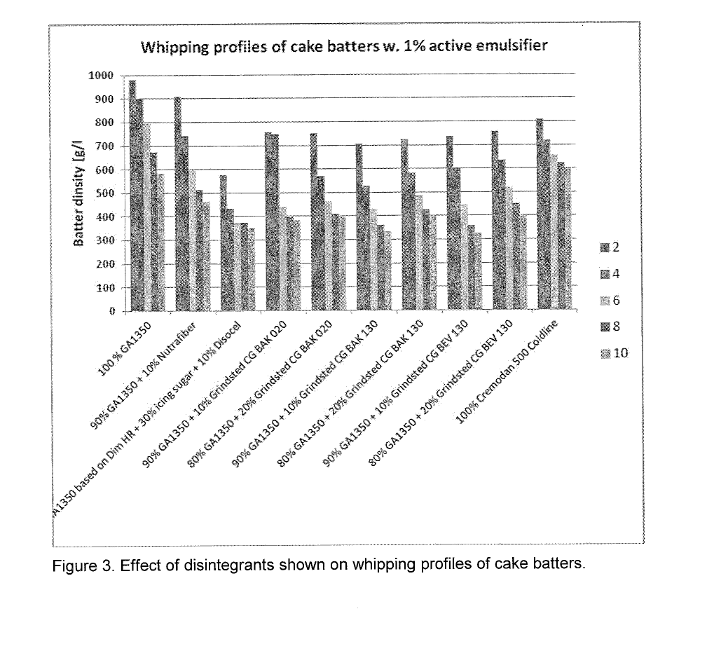

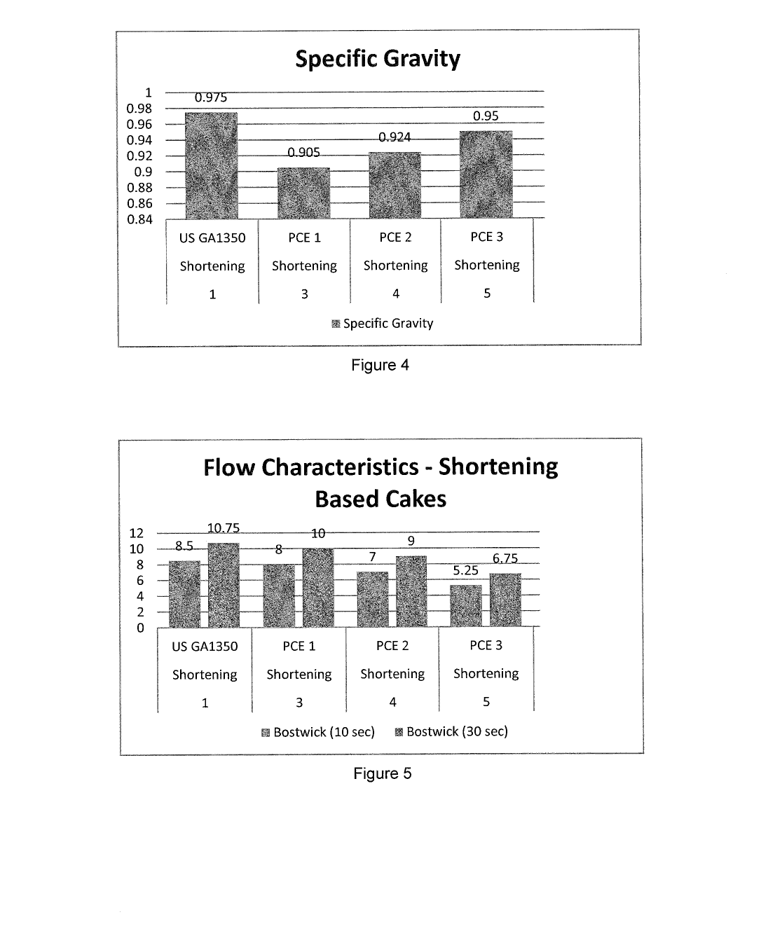

When comparing specific gravities of all samples to the US GA-1350, all samples had improved specific gravity. Comparison of viscosity/flow characteristics of samples compared to GA-1350 demonstrated an improvement in the remaining samples due to thicker fluidity. The results are shown in FIGS. 4 and 5.

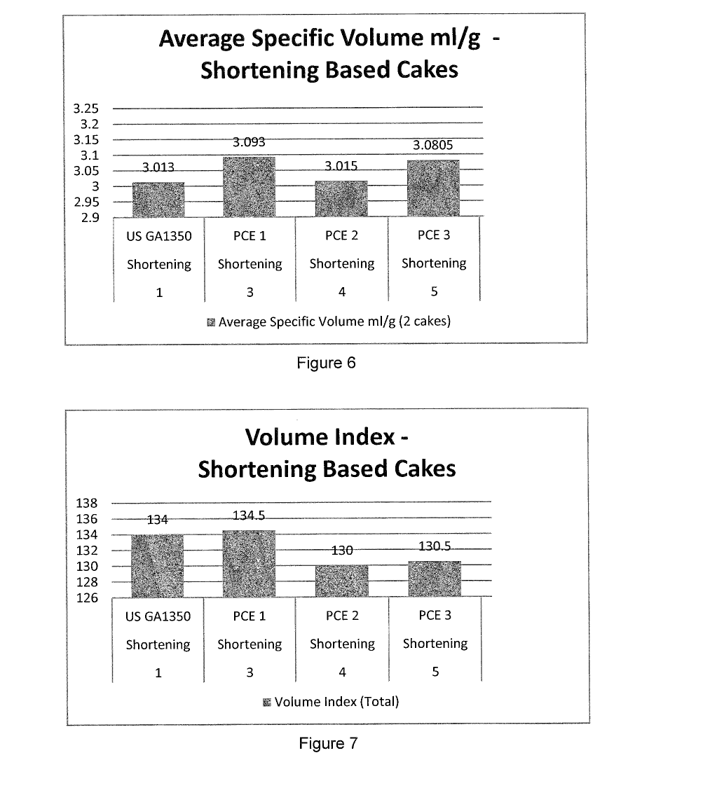

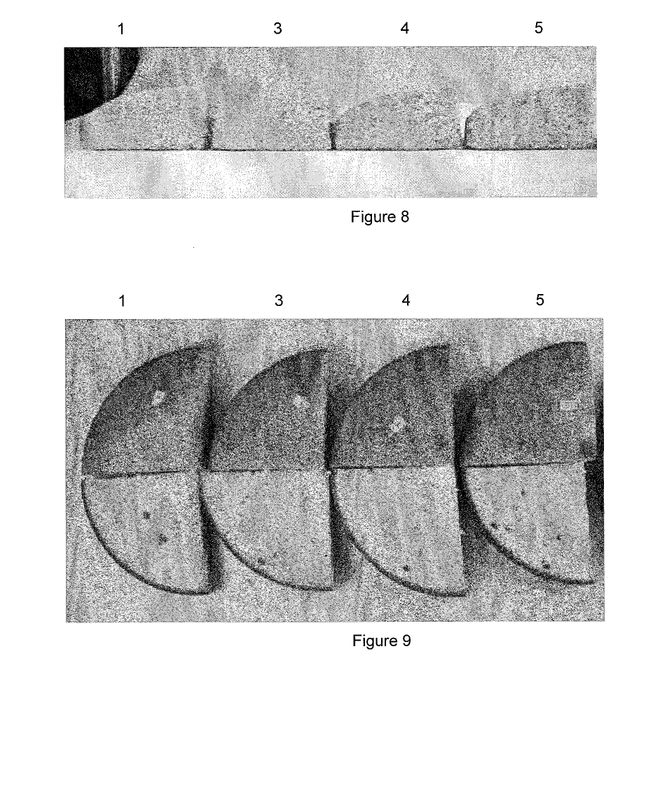

Specific volume of the cakes, when compared to GA-1350, showed comparable or improved characteristics in the remaining samples. However, volume index measured with a template and examining the center cake height measurements shows an improvement in the PCE1 sample, but lower center height characteristics in the remaining PCE samples. The results are shown in FIGS. 6 and 7. Cross Sectional Photographs of finished samples are shown in FIGS. 8 and 9.

Oil Based Cake Processing and Evaluation. Base mix recipe and procedure using Hobart N50 Mixer and Cuisinart DLC-X Plus Food Processor.

| | Oil |
|---|---|
| Ingredient | Formula |
| Granulated Sugar | 400.6 |
| All Purpose Shortening | 0.0 |
| Emulsifier | 11.0 |
| High Ratio Cake Flour | 333.9 |
| Dried Whole Egg Solids | 50.1 |
| NFDM | 26.7 |
| Dried Egg White Solids | 16.7 |
| Salt | 11.7 |
| Instant Clearjel Modified Starch | 10.0 |
| Danisco CMC BAK 130 | 0.7 |
| Danisco Xanthan 80 | 0.8 |
| Sodium Bicarbonate | 8.3 |
| SALP | 2.2 |
| SAS | 4.2 |
| Sorbic Acid | 0.5 |
| | 877.5 |

### Equipment:

### Hobart N50 Mixer, Hobart-Troy, Ohio

### Panasonic Microwave Oven NN-T9945F, Panasonic—Secaucus, N.J.

### Cuisinart DLC-X Plus Food Processor, Cuisinart-East Windsor, N.J.

### Procedure for Oil Based Mix:

1. Blend minor ingredients (Whole Egg, Nonfat Dried Milk, Egg White, Salt, Clearjel Starch, CMC, Xanthan 80, Sodium Bicarbonate, SALP, Sorbic Acid, SAS) in Hobart mixer bowl for 5 minutes. Set aside.
2. In separate mixer bowl, add sugar. Add minors and flour to mixer. Blend for 3 minutes on LOW speed.
3. Transfer contents of mixer bowl to food processor bowl and seal.
4. While running for 1 minute, add emulsifier.
5. Scrape food processor bowl thoroughly, and mix for 1 additional minute.
6. Package mix and store until use.

### Cake Mixing Recipes and Procedures:

| | Oil |
|---|---|
| Batter | Grams |
| Dry Mix | 0 |
| Dry Mix (No Shortening) | 713.3 |
| Water | 387.1 |
| Oil | 99.6 |
| Total | 1200 |

### Equipment:

### Hobart N50 Mixer, Hobart—Troy, Ohio

### Reed Oven, Reed Oven Company—Kansas City, Mo.

### Procedure for Oil Based Cakes

Add dry mix to mixer.
Add 40% of water (155 g) and oil to mixer.

### Mix 2 min LOW, SCRAPE, Mix 1.5 min MEDIUM.

Add remainder of water (232.1 g).

### Mix 1.5 min LOW, SCRAPE, Mix 1.5 min LOW.

### Scale at 425 g

### Bake 27 to 28 min at 365°

Data from Analysis—Oil Based Cakes

All attributes demonstrated improvement in oil based cakes when using the PCE samples compared to the GA 1350 sample.

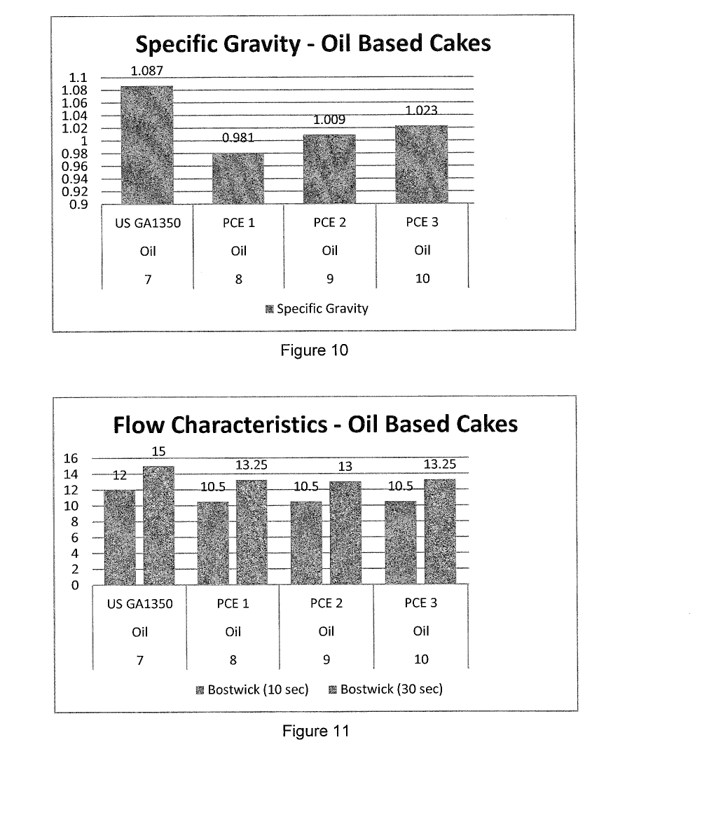

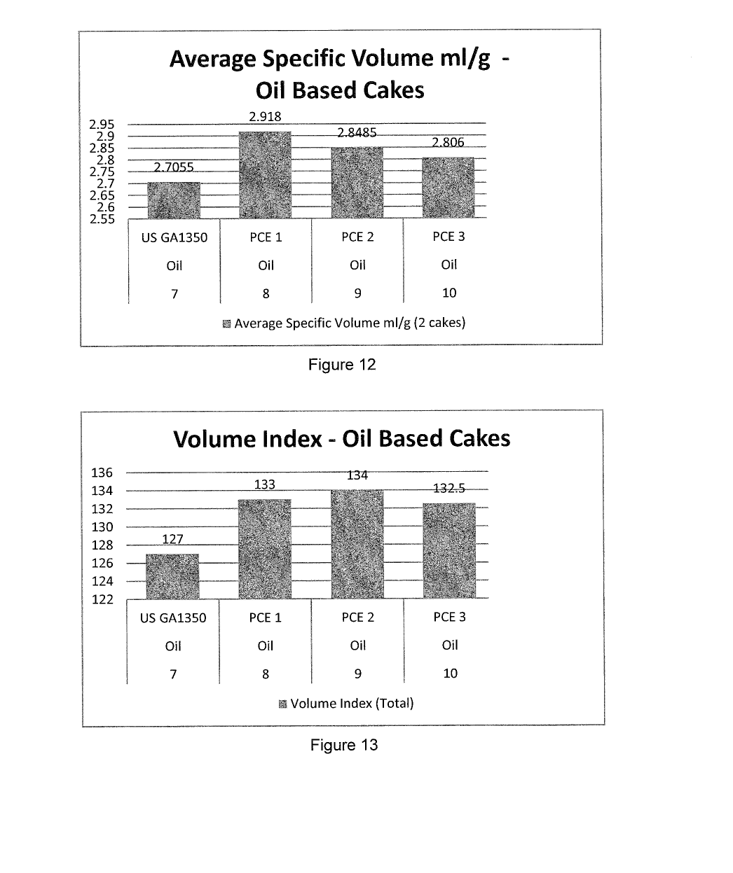

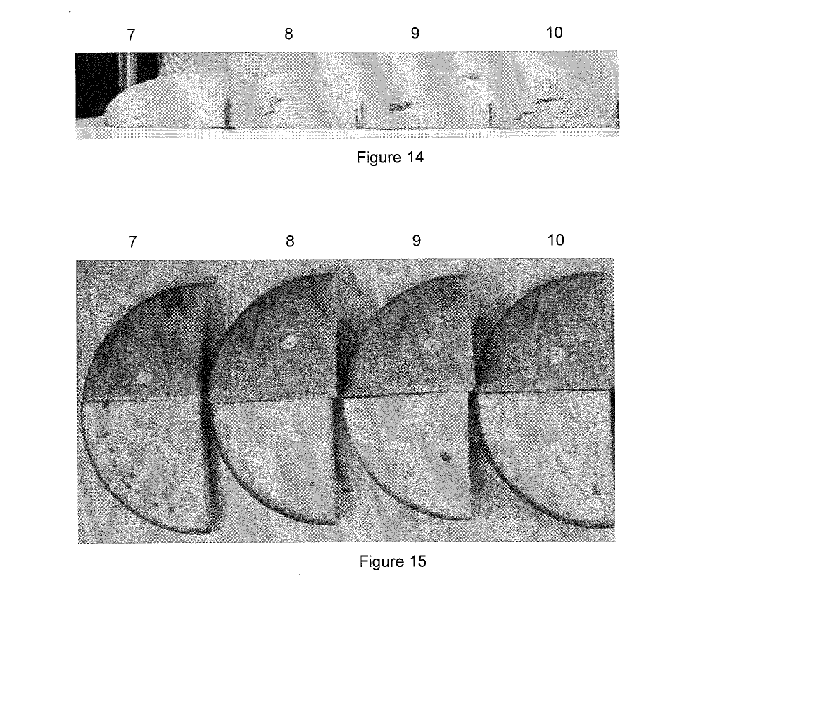

PGE2 and PCE3 have lower specific volumes when compared to PCE1, but the center volume is increased as demonstrated in the differences noted on the template volume chart. The results are shown in FIGS. 10, 11, 12 and 13. Cross Sectional Photographs of finished samples are shown in FIGS. 14 and 15.

### Observations:

All samples show improvement over the current product GA-1350.

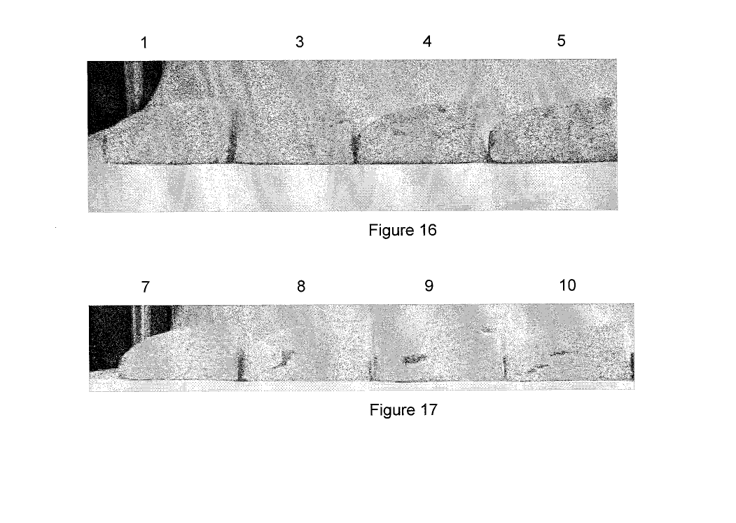

While the specific gravities of the oil based cakes were higher than those in the shortening based cakes, it should be noted that the template volume for the PCE1 Oil based cake is very similar to the PCE1 shortening based cake in this system. Cross Sectional Photographs of finished samples are shown in FIGS. 16 and 17.

### DISCUSSION

The quality of the low shear products are evaluated by their whipping performance and their baking performance. In relation to whipping performance a cake batter is mixed in a Hobart mixer. Every two minutes the batter density is measured and the results are compiled into a whipping profile containing 6 values. The values cover batter densities starting at 2 minutes and ending at 12 minutes. Two parameters are of importance in a whipping profile. First the batter density needs to decline as fast as possible. Secondly the lowest density needs to be as low as possible. A low batter density indicates that a high amount of air has been incorporated into the batter. Secondly the baking performance is of importance. A batter with a too low batter density tends to be unstable and collapse during the baking process. Therefore a good whipping emulsifier is one that gives good whipping performance along with a good baking stability.

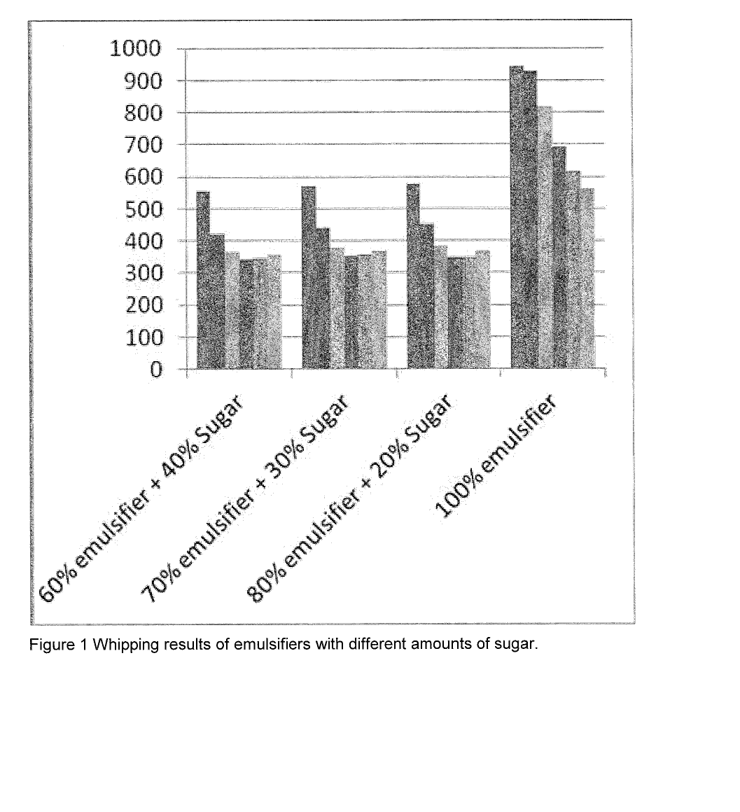

In FIG. 1 it can be seen that a combination of emulsifiers and icing sugar greatly improves the whipping performance of sponge cake batter. The three products (1-3) that contain icing sugar all perform better than the pure emulsifier (4). It can also be seen that the two products (1-2) that contain 30% and 40% of icing sugar decrease in batter density faster than the product that contains only 20% of icing sugar. All three samples that contain sugar ends more or less at the same batter density after 12 minutes.

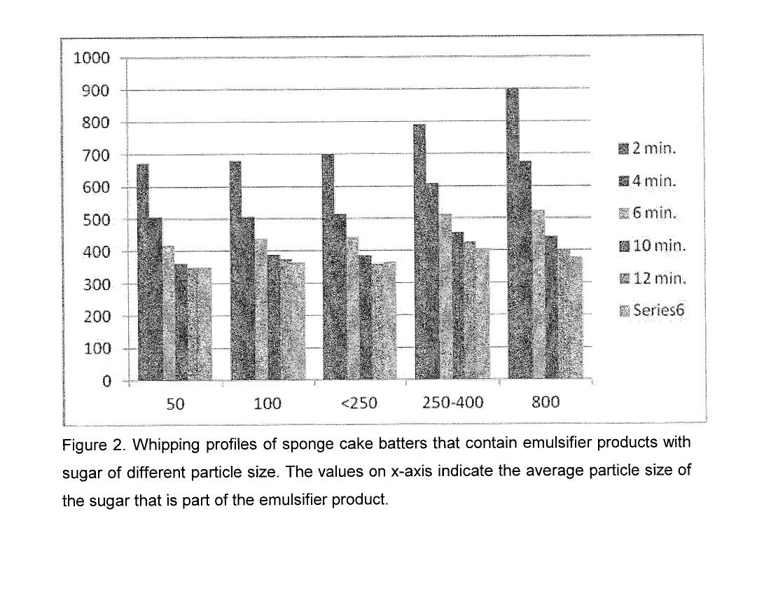

It has also been proved that the particle size of the sugar is of great importance. The smaller the particles that are used the better hydrations is observed. This has been proved by testing a range of sugars starting at a sugar that have an average particle size of 50 μm and ending at a type having an average particle size of 800 μm. In between the two extremes three other sugars with different average particle sizes were tested. This is illustrated in FIG. 2.

In FIG. 2 it can be seen that the batter density decreases when the emulsifier contains sugar particles with a smaller average particle size. Both the speed at which the batter density decreases as well as the final density benefits from the smaller particles. The same tendency has also been shown for other sugars, hydrocolloids and fibres.

The following ingredients have been tested for their erosion properties:
Sugar
   Icing sugar: 50 μm
   Milled sugar: 100 μm
   Granulated sugar: <250 μm
   Caster sugar: 250-400 μm
   Regular sugar: 800 μm
Baking powder
Mannitol
   PEARLITOL® 50C
   PEARLITOL® 100SD
   PEARLITOL® 160C
   PEARLITOL® 200SD
Maltodextrin DE20

### Cake Structure and Baking Performance.

From the baking tests it has been seen that products that contain disintegrants has a more even crumb structure and tend to give a more stable batter and thereby a product with a slightly higher baked volume. Especially the products that contain Fibrex® seem to produce cakes with a “better” crumb and higher volume.

### Example 10

### Study of the Effect of Hydrating Emulsifiers

An emulsifier combination as described in Example 1 (GRINDSTED® GA1350) and mixed according to the following recipes were tested:

### 100 wt. % GA1350

70 wt. % GA1350+30 wt. % icing sugar
69 wt. % GA1350+1 wt. % Polysorbate 80+30 wt. % icing sugar
68 wt. % GA1350+2 wt. % Polysorbate 80+30 wt. % icing sugar
66 wt. % GA1350+4 wt. % Polysorbate 80+30 wt. % icing sugar

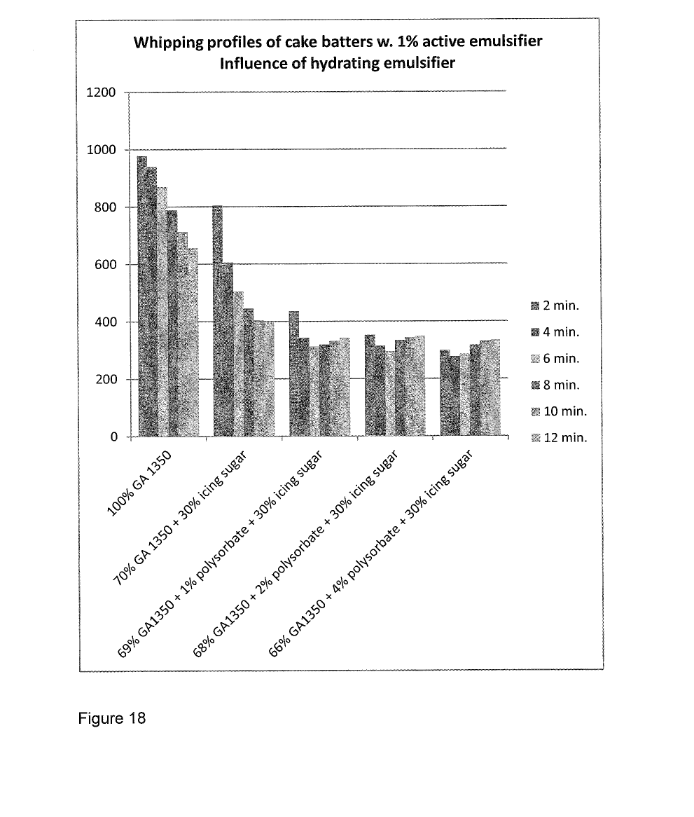

Polysorbate 80 is available from Esterchem, Staffordshire, UK. The samples were tested according to the procedure described under “Materials and Methods” in procedure 2—“Mixing procedure using a Hobart N50 Mixer”. The whipping performance can be seen in FIG. 18.

It is clearly seen that a very hydrophilic emulsifier, such a Polysorbate 80, improves the whipping performance. Compared to the product without Polysorbate 80 and icing sugar, the improvements are in the range of 100% depending of the concentration of polysorbate.

### REFERENCES

H. Omidian, K. Park: Swelling agents and devices in oral drug delivery; J. Drug Del. Tech., 18 (2) 83-93 2008.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. A composition comprising
(a) a food ingredient, the hydration of which is to be enhanced;
(b) a water soluble particulate material, having an average particle size of from 10 to 1000 μm;
wherein the food ingredient and the water soluble particulate material are integrated with each other.

2. A composition according to claim 1 wherein the food ingredient is selected from the group consisting of emulsifiers, triglycerides, fatty acids and hydrocolloids.

3. A composition according to claim 1 wherein the food ingredient is selected from the group consisting of emulsifiers.

4. A composition according to claim 3 wherein the emulsifier is selected from the group consisting of propylene glycol monostearate (PGMS), sodium stearoyl lactylate (SSL), calcium stearoyl lactylate (CSL), monoglycerides, diglycerides, monodiglycerides, polyglycerol esters, lactic acid esters of monoglycerides or of diglycerides or of monodiglycerides, polysorbate, sucrose esters of monoglycerides or of diglycerides or of monodiglycerides, diacetyl tartaric acid esters of monoglycerides or of diglycerides or of monodiglycerides (DATEM), citric acid esters of monoglycerides or of diglycerides or of monodiglycerides (CITREM) and combinations thereof.

5. A composition according to claim 1 wherein the food ingredient is an emulsifier selected from the group consisting of monoglycerides.

6. A composition according to claim 1 wherein the water soluble particulate material is selected from the group consisting of sugars, sugar alcohols, salts and combinations thereof.

7. A composition according to claim 6 wherein the water soluble particulate material is selected from the group consisting of sugars, sugar alcohols and combinations thereof.

8. A composition according to claim 6 wherein the water soluble particulate material is one or more sugars.

9. A composition according to claim 7 wherein the sugar or sugar alcohol is selected from the group consisting of sucrose, lactose, glucose, maltose, mannitol and combinations thereof.

10. A composition according to claim 7 wherein the sugar or sugar alcohol is selected from the group consisting of sucrose, mannitol and combinations thereof.

11. A composition according to claim 1 wherein the water soluble particulate material has an average particle size of from 50 to 800 μm.

12. A composition according to claim 1 wherein the water soluble particulate material is selected from sucrose and mannitol, and has an average particle size of from 50 to 800 μm.

13. A composition according to claim 1 wherein the food ingredient is present in an amount of at least 50 wt. % based on the weight of the composition.

14. A composition according to claim 1 wherein the food ingredient is present in an amount of at least 70 wt. % based on the weight of the composition.

15. A composition according to claim 1 wherein the food ingredient is present in an amount of at least 90 wt. % based on the weight of the composition.

16. A composition according to claim 1 wherein the ratio of food ingredient to water soluble particulate material is from 5:1 to 1:5, based on weight.

17. A composition according to claim 1 wherein the ratio of food ingredient to water soluble particulate material is from 5:1 to 1:1, based on weight.

18. A composition according to claim 1 wherein the composition further comprises
(c) a disintegrant.

19. A composition according to claim 18 wherein the disintegrant is selected from the group consisting of hydrocolloids, edible fibres and combinations thereof.

20. A composition according to claim 19 wherein the disintegrant is selected from the group consisting of cellulose, carboxymethyl cellulose, sugar beet fibre and combinations thereof.

21. A composition according to claim 19 wherein the disintegrant is selected from edible fibres.

22. A composition according to claim 21 wherein the composition further comprises an edible fibre in an amount of no greater than 10 wt % based on the weight of the composition.

23. A composition according to claim 21 wherein the edible fibre is selected from the group consisting of sugar beet fibre, apple fibre, pea fibre, wheat fibre, oat fibre, barley fibre, rye fibre, rice fibre, potato fibre, tomato fibre, other plant non-starch polysaccharide fibres, and combinations thereof.

24. A composition according to claim 23 wherein the edible fibre is at least a sugar beet fibre.

25. A composition according to claim 1 wherein the food ingredient and the water soluble particulate material are spray crystallised such that the food ingredient and the water soluble particulate material are integrated with each other.

26. A process for the preparation of composition comprising
(a) a food ingredient, the hydration of which is to be enhanced;
(b) a water soluble particulate material, having an average particle size of from 10 to 1000 μm;
the process comprising
i) providing an initial composition comprising the food ingredient and the water soluble particulate material,
ii) spray crystallising the initial composition such that the food ingredient and the water soluble particulate material are integrated with each other.

27. A process according to claim 26 wherein in step i), the initial composition comprising the food ingredient is in a melted form.

28. A process according to claim 26 wherein the initial composition is substantially free of free water.

29. A composition obtainable by the process of claim 26.

30. (canceled)

31. A bakery product comprising or prepared from a composition as defined in claim 1.

32. A whipped foodstuff comprising or prepared from a composition as defined in claim 1.

33. A method for improving the hydration of a food ingredient comprising using a water soluble particulate material having an average particle size of from 10 to 1000 μm in a food ingredient, wherein the food ingredient and the water soluble particulate material are integrated with each other.

34.-36. (canceled)
